(19) United States
(12) Patent Application Publication
(10) Pub. No.: US 2021/0189644 A1
(43) Pub. Date: Jun. 24, 2021

(54) INKJET PRINTING ON POLYESTER TEXTILES

(71) Applicant: SENSIENT IMAGING TECHNOLOGIES SA, Morge (CH)

(72) Inventors: CLAIRE GLENAT, Morges (CH); PAOLO SOLIGO, Morges (CH); RUDY GROSSO, Morges (CH)

(21) Appl. No.: 16/614,219

(22) PCT Filed: May 17, 2018
(86) PCT No.: PCT/EP2018/062866

§ 371 Date: Nov. 15, 2019

(30) Foreign Application Priority Data
May 19, 2017 (GB) 1708102.7

(51) Int. Cl. D06P 5/30; D06P 5/00; D06P 5/20; D06P 3/54; B41M 5/00; B41M 7/00

(52) U.S. Cl. CPC D06P 5/30; D06P 5/002; D06P 5/2016; D06P 5/2077; D06P 1/16; B41M 5/0011; B41M 5/0064; B41M 5/0047; B41M 7/009; D06P 3/54

(57) ABSTRACT

A method of pre-treating a polyester textile for inkjet printing with a water-based disperse dye ink composition, which method comprises treating at, least a part of, a surface of the polyester textile to increase its hydrophobicity.

The present disclosure is generally concerned with methods for inkjet printing water-based disperse dye ink compositions on polyester textiles as well as with printed polyester textiles obtained by the methods.

Traditional textile printing typically requires a huge amount of water. Water is involved during the fixation process of printed dyes and very large amounts of water are used to wash the textiles of excess dye and auxiliary chemicals which remain after the fixation process.

Digital textile printing processes, such as inkjet printing, offer the possibility of reduced water consumption. Digital printing involves less contact of chemicals with the surface of the textile and, therefore, less washing as compared with traditional textile printing.

Generally, however, digital textile printing calls for inks of much lower viscosity as compared to those used for conventional textile printing. Consequently, the textiles are normally treated before printing in order that the printed inks have sufficient colour fastness and an excessive rinsing is not required to remove residual colorant.

The pre-treatment of textiles may comprise a wet method such as dip or spray coating—with subsequent drying. Alternatively, the pre-treatment may comprise a dry method such as a corona or plasma treatment.

The pre-treatment of polyester textiles depends on the type of ink which is to be digitally printed. In the case that a pigment ink is to be used, the pre-treatment may, in particular, comprise coating the polyester textile with a cationic polymer such as a cationic polyurethane (see for example, WO 2014/039306 A1 and references therein) or etching with an atmospheric pressure plasma generated from a mixture of an inert gas and an oxygen containing gas (see for example, Zhang C. and Fang K, in Surface and Coatings Technology 2009, 203, 2058-2063).

Digital textile printing to polyester textiles may, therefore, be similar to traditional textile printing in that the fabric is pre-treated to warrant sharp image quality and image vividness, the printed image is fixed by steaming (typically for 20 minutes in saturated vapour at 102° C.) and the fabric is washed to remove unfixed dyes and chemicals and dried.

International Patent Application No. WO 2014/127050 A1 discloses disperse dye ink compositions which are suitable for digital textile printing of polyester textiles without the need for pre-treatment or to treat the image with steam.

The ink compositions, which have relatively high surface tension, comprise a disperse dye and an aqueous carrier comprising a (monomeric) polyol having at least 5 carbon atoms, may provide for direct digital printing of polyester textiles with reduced fixation time as compared to traditional textile printing and with a print quality which passes the Oeko-Tex® Standard 100 test without rinsing.

These ink compositions may provide, therefore, for printing of polyester textiles in a manner that is substantially free from the use of water as compared to traditional printing of polyester textiles.

The present disclosure is concerned with digital printing to polyester textiles and, in particular, to a pre-treatment of polyester textiles which permits improved decoration with water-based, disperse dye ink compositions having high surface tension such as those disclosed in International Patent Application No. WO 2014/127050 A1.

The pre-treatment is particularly suitable for inkjet printing of the water-based disperse dye compositions on low commercial grade polyester textiles, such as those found in the fast fashion industry.

The pre-treatment provides that a surface of the treated polyester textile is more even and has lower surface free energy as compared to that of the untreated polyester textile. Note, therefore, that the pre-treatment is different to the plasma treatments mentioned above because the latter increase the surface roughness and surface free energy of the textile.

Accordingly, in a first aspect the present disclosure provides a method of pre-treating a polyester textile for inkjet printing with a water-based disperse dye ink composition, which method comprises treating at, least a part of, a surface of the textile to increase its hydrophobicity.

In one embodiment, the method comprises treating the surface so as to provide it with a hydrophobic coating of a polymer.

Any suitable method may be used for forming the hydrophobic coating on the textile. Suitable methods include wet pre-treatments, although a dry pre-treatment is preferred to minimise or avoid the consumption of water.

In embodiments, the method comprises forming the hydrophobic coating by a chemical vapour deposition of a fluorine-containing polymer or a silicon-containing polymer.

The fluorine-containing polymer may be formed directly from a fluorine-containing monomer. Alternatively, the fluorine-containing polymer may be formed by plasma treatment of an organic polymer not containing fluorine with a fluorine-containing compound, such as CF₄.

In one embodiment, the method comprises forming the hydrophobic coating by a plasma process using a silicon-containing or fluorine-containing monomer. The method may, in particular, use an atmospheric pressure plasma process, such as a dielectric barrier discharge plasma process, a piezoelectric direct discharge plasma process, a corona discharge plasma process, a plasma torch process or a plasma jet process.

In preferred embodiments, the method comprises forming a coating of a hydrophobic polymer on the polyester textile by a dielectric barrier discharge (DBD) plasma process in an inert gas (such as helium or argon) or in a mixture an inert gas and oxygen (or air) using one or more of a silicon-containing compound.

The silicon-containing compound may be a silanol, such as trimethylsilanol or triethylsilanol, or a siloxane, such as hexamethyldisiloxane, octamethyltrisiloxane, decamethyltetra-siloxane, dodecamethylpentasiloxane, tetradecamethylheptasiloxane, 2,4,6,8-tetramethylcyclotetrasiloxane, octamethylcyclotetrasiloxane, decamethylcyclopentasiloxane and dodecamethylcyclohexasiloxane.

The process conditions may provide a continuous coating of polymer on the surface of the textile. But the hydrophobic coating need not be continuous—it being sufficient to cover the major portions of the yarns forming the printing surface of the fabric.

The process conditions may provide a thickness for the hydrophobic coating on the yarns between 0.5 μm and 5 μm, for example, 1 μm or 2 μm.

The pre-treatment may comprise a batch or a roll-to-roll process in which the polyester textile is exposed to a plasma generated by a dielectric barrier discharge to air containing, for example, hexamethyldisiloxane.

The exposure may comprise repeated exposures for short periods of time. But the total exposure should not be so great as to raise the surface free energy of the treated surface by forming a silica-like (SiO₂) coating.

In one embodiment, a roll-to-roll process feeds the polyester textile to a plasma source coupled to an air flow containing, for example, hexamethyldisiloxane.

The process conditions and the number of exposures may also be chosen so that the hydrophobic coating provides a degree of sharpness for a digitally printed image on the printing surface of the polyester textile which is better than that of a correspondingly printed image on the untreated polyester textile.

In one embodiment, comprising a roll-to-roll process, the temperature of the exposure may be between 120° C. and 200° C. (for example, 140° C.), the power may be between 200 W and 1000 W (for example, 690 W), the flow rate of the air mixture to the plasma source may be between 0.75 ml/min and 1.5 ml/min (for example, 1.2 ml/min) and the feed rate of the fabric to plasma source may be between 5 m/min and 10 m/min (for example, 8 m/min).

Note that references herein to a polyester textile are references to textiles comprising polyester fibre alone or to textiles comprising a blend of polyester fibre and another fibre, such as cotton or Lycra®, in which the amount of polyester in the textile is greater than 50 w/w %, and, in particular, greater than 80 w/w %, 90 w/w % or 95 w/wt %.

Note further that the method is not limited by the weight or thickness of the polyester textile. The polyester textile may have a weight per unit area of between 5 g/m² and 250 g/m². It may comprise a woven or knitted polyester fabric. It may comprise a low commercial grade polyester textile and, in particular, a woven polyester fabric having weight per unit area between 10 g/m² and 100 g/m².

In some embodiments, the polyester textile comprises a woven polyester fabric of weight per unit area between 50 g/m² and 90 g/m², for example, 60 g/m², 70 g/m² or 80 g/m².

The pre-treatment offers improved decoration by inkjet printing with a water-based, disperse dye ink composition of high surface tension not only because the pre-treatment evens out the surface of the polyester textile but also because it lowers the surface free energy of the polyester textile.

Without the pre-treatment, bleeding and over-penetration of the water-based, disperse dye ink composition of high surface tension can occur—resulting in an unsatisfactory sharpness and/or colour density in the image printed on the printing surface of the textile as well as the production of a printed image towards or on the back surface of the polyester textile.

The degree of sharpness of a digitally printed image on the printing surface of the polyester textile may correlate with the difference in the surface tension of the water-based, disperse dye ink composition and the surface free energy of the polyester textile.

This difference may be managed by selection of the polymer to be deposited and/or the process conditions (for example, power, time and flow rate of monomer in an atmospheric plasma process) by which it is deposited on the polyester textile.

The pre-treatment should not, however, lower the surface free energy of the polyester textile to an extent that prevents inkjet printing.

The difference may also be managed by selection of the water-based, disperse dye ink composition. But the surface tension of the water-based disperse dye ink composition should not be so high that it is not suitable for inkjet printing with the appropriate inkjet printers.

However, the pre-treatment does not necessarily require that the surface free energy of the treated polyester textile is measured or even that is measurable. The suitability of the pre-treatment can be determined by inkjet printing with a reference water-based disperse dye ink composition (for example, by printing a grey scale with the black water-based disperse dye ink composition of Table 4 below).

Note in this regard, that the surface free energy of a low commercial grade polyester textile (for example, one having weight per unit area 10 g/m² and 100 g/m²) is not normally measurable—because the permeability of the polyester textile to water or to aqueous based solvents does not permit a drop to establish with a measurable surface contact angle.

But the method may provide that the treated polyester textile has a measurable surface free energy because the surface is substantially more hydrophobic as compared to that of the untreated woven polyester textile.

The water-based disperse dye ink composition may have a surface tension of between 35 dyne/cm (35 mN/m) and 50 dyne/cm (50 mN/m), in particular, between 40 dyne/cm (43 mN/m) and 50 dyne/cm (50 mN/m), and, for example, between 43 dyne/cm (43 mN/m) and 50 dyne/cm (50 mN/m).

In some embodiments, the pre-treatment provides a hydrophobic polymer coating which imparts a measurable surface free energy to the polyester textile which is 5 dynes/cm (5 mN/m) to 30 dynes/cm (30 mN/m), for example, 10 dynes/cm (10 mN/m) to 15 dynes/cm (15 mN/m), lower than the surface tension of the water-based disperse dye ink composition.

Accordingly, in some embodiments, the method may impart a measurable surface free energy to the polyester textile which is between 15 dynes/cm (15 mN/m) and 35 dynes/cm (35 mN/m).

In certain embodiments, the method comprises pre-treating a polyester textile comprising a woven fabric of weight per unit area 10 g/m² to 100 g/m² so that it has a measurable surface free energy of between 15 dynes/cm (15 mN/m) and 35 dynes/cm (35 mN/m).

References herein to measurable surface free energy values are references to a surface free energy values determined at room temperature (22° C.) by a drop shape analysis based on the work model (see Owens, D, and Wendt, R. in J. Appl. Polym. Sci. 1969, 13, 1741-1747) reflecting polar and disperse contributions (as determined by water and diiodomethane) in Young's equation describing the relationship between contact angle, surface tension and surface free energy.

A Krüss (Hamburg, Germany) Mobile Surface Analyser (MSA) and its associated software ADVANCE is particularly suitable for determining the surface energy of the treated polyester fabric.

Note, however, that the measurement of surface free energy following the pre-treatment can be problematic on low commercial grade polyester textiles. And that, in some cases, the appropriate pre-treatment for the inkjet printing may best be obtained by trial and error.

In a second aspect, the present disclosure provides a method of printing to a polyester textile, which method comprises pre-treating, at least a part of, a surface of a polyester textile so as to increase its hydrophobicity; inkjet printing a water-based-disperse dye ink composition on the treated surface of the polyester textile; and heating the polyester textile so as to fix the printed image on the treated surface of the polyester textile.

As mentioned above, the pre-treatment may provide the surface of the polyester textile with a hydrophobic coating. It may use any suitable method for doing so—although a dry pre-treatment is preferred.

In one embodiment, the method comprises forming the hydrophobic coating by a chemical vapour deposition of a fluorine-containing polymer or a silicon-containing polymer.

The fluorine-containing polymer may be formed directly from a fluorine-containing monomer. Alternatively, the fluorine-containing polymer may be formed by plasma treatment of an organic polymer not containing fluorine with a fluorine-containing compound, such as CF₄.

In one embodiment, the method comprises forming the hydrophobic coating by a plasma process using a silicon-containing or fluorine-containing monomer. The method may, in particular, use an atmospheric pressure plasma process, such as a dielectric barrier discharge plasma process, a piezoelectric direct discharge plasma process, a corona discharge plasma process, a plasma torch process or a plasma jet process.

In preferred embodiments, the method comprises pre-treating the surface by forming a hydrophobic polymer coating on the polyester textile by a dielectric barrier discharge (DBD) plasma process in an inert gas (such as helium or argon) or in a mixture of an inert gas and oxygen (or air) using one or more of a silicon-containing compound.

The silicon-containing compound may be a silanol, such as trimethylsilanol or triethylsilanol, or a siloxane such as hexamethyldisiloxane, octamethyltrisiloxane, decamethyltetra-siloxane, dodecamethylpenta-siloxane, tetradecamethylheptasiloxane, 2,4,6,8-tetramethylcyclo-tetrasiloxane octamethylcyclotetrasiloxane, decamethylcyclopenta-siloxane and dodecamethylcyclohexasiloxane.

The process conditions may provide a continuous coating of polymer on the surface of the textile. But the hydrophobic coating need not be continuous—it being sufficient to cover the major portions of the yarns forming the printing surface of the fabric.

The process conditions may provide a thickness for the coating may be between 0.5 μm and 5 μm, for example, 1 μm or 2 μm.

The pre-treatment may, in particular, comprise a batch or a roll-to-roll process in which the polyester textile is exposed to an atmospheric plasma generated by a dielectric barrier discharge to air containing, for example, hexamethyldisiloxane.

The exposure may comprise repeated exposures for short periods of time. In any case, the total exposure should not be so great as to raise the surface energy of the treated surface by forming a silica-like (SiO₂) coating.

In one embodiment, a roll-to-roll process feeds the polyester textile to a plasma source coupled to an air flow containing hexamethyldisiloxane.

The process conditions and the number of exposures may also be chosen so that the hydrophobic coating provides a degree of sharpness of a digitally printed image on the printing surface polyester textile which is better than that of a correspondingly printed image on the untreated polyester textile.

In one embodiment, comprising a roll-to-roll process, the temperature of the exposure may be between 120° C. and 200° C. (for example, 140° C.), the power may be between 200 W and 1000 W (for example, 690 W), the flow rate of the air mixture to the plasma source may be between 0.75 ml/min and 1.5 ml/min (for example, 1.2 ml/min) and the feed rate of the fabric to plasma source may be between 5 m/min and 10 m/min (for example, 8 m/min).

In embodiments, the method is directed to inkjet printing the ink composition on a polyester textile comprising polyester fibre alone or a blend of polyester fibre and another fibre, such as cotton or Lycra®, in which the amount of polyester in the textile is greater than 50% w/w %, and, in particular, greater than 80 w/w %, 90 w/w % or 95 w/w %.

As mentioned above, the polyester textile may have a weight per unit area between 5 g/m² and 250 g/m². It may comprise a woven or knitted polyester fabric. It may comprise a low commercial grade polyester textile and, in particular, a woven polyester fabric having weight per unit area between 10 g/m² to 100 g/m².

In some embodiments, the polyester textile comprises a woven polyester fabric of weight per unit area between 50 g/m² and 90 g/m², for example, 60 g/m², 70 g/m² or 80 g/m².

As mentioned above, the degree of sharpness of a digitally printed image on the printing surface of the polyester textile may correlate with the difference between the surface tension of the water-based, disperse dye ink composition and the surface free energy of the polyester textile.

This difference may be managed by selection of the polymer to be deposited and/or the process conditions (for example, power, time and flow rate of monomer in an atmospheric plasma process) by which it is deposited on the polyester textile.

The pre-treatment should not, however, lower the surface free energy of the polyester textile to an extent that prevents inkjet printing.

The difference may also be managed by selection of the water-based, disperse dye ink composition. But the surface tension of the water-based, disperse dye ink composition should not be so high that it is not suitable for inkjet printing with the appropriate inkjet printers.

However, the pre-treatment does not necessarily require that the surface free energy of the treated polyester textile is measured or even that is measurable. The suitability of the pre-treatment can be determined by inkjet printing with a reference water-based disperse dye ink composition (for example, by printing a grey scale with the black water-based disperse dye ink composition of Table 4 below).

Note in this regard, that the surface free energy of a low commercial grade polyester textile (for example, one having weight per unit area 10 g/m² and 100 g/m²) is not normally measurable—because the permeability of the polyester textile to water or to aqueous based solvents does not permit a drop to establish with a measurable surface contact angle.

But the method may provide that the treated polyester textile has a measurable surface free energy because the surface is substantially more hydrophobic as compared to that of the untreated woven polyester textile.

In some embodiments, the water-based disperse dye ink composition used in the inkjet printing may have a surface tension of between 35 dyne/cm (35 mN/m) and 50 dyne/cm (50 mN/m), in particular, between 40 dyne/cm (43 mN/m) and 50 dyne/cm (50 mN/m), and, for example, between 43 dyne/cm (43 mN/m) and 50 dyne/cm (50 mN/m).

In some embodiments, the pre-treatment provides a hydrophobic polymer coating which imparts a measurable surface free energy to the polyester textile which is 5 dynes/cm (5 mN/m) to 30 dynes/cm (30 mN/m), for example, 10 dynes/cm (10 mN/m) to 15 dynes/cm (15 mN/m), lower than the surface tension of the water-based disperse dye ink composition.

Accordingly, in some embodiments, the method may impart a measurable surface free energy to the polyester textile which is between 15 dynes/cm (15 mN/m) and 35 dynes/cm (35 mN/m).

In certain embodiments, the method comprises pre-treating a polyester textile comprising a woven fabric of weight per unit area 10 g/m² to 100 g/m² so that it has a measurable surface free energy of between 15 dynes/cm (15 mN/m) and 35 dynes/cm (35 mN/m).

The inkjet printing may comprise inkjet printing directly (“direct printing”) onto the treated polyester textile or inkjet printing onto a transfer paper and transferring the printed image from the transfer paper onto the treated polyester textile (“indirect printing”).

The inkjet printing may further comprise heating the polyester textile from about 100° C. to about a melting point of the polyester textile so as to fix the printed image on the treated surface of the polyester textile.

The inkjet printing may use any inkjet printer suitable for digitally printing images on a textile. Suitable printers include the Nassenger Pro 60 or Nassenger Pro 1000 inkjet printer (available from Konica Minolta) as well as the MS LaRio inkjet printer (available from MS Printing Solutions) and the Reggiani ReNOIR compact inject printer (available from EFI Reggiani).

The inkjet printing may, in particular, be carried out to a resolution (in x and y directions) between 300 dots per inch (dpi) and 800 dots per inch (for example 600 dots per inch). The printing speed may be between 35 linear m/minute and 75 linear m/minute in single pass printing configuration or between 10 m²/hour and 600 m²/hour in scanning configuration.

The shortest possible interval between inkjet printing and heating to fix the printed image on the treated surface of the polyester textile may also allow control over bleeding and over-penetration of the water-based disperse dye ink composition on the polyester textile.

In preferred embodiments, therefore, the inkjet printing comprises inkjet printing directly onto the treated polyester textile and heating the polyester textile to a temperature of at least 100° C., for example to 120° C. or 130° C., within 60 seconds or less of having completed the inkjet printing.

In embodiments comprising a roll-to-roll process, the method may employ apparatus including an “in-line heater” so that the roll has not to be removed for the heating.

Although a wet heating may be used, the method preferably employs a dry heating so as to minimise or avoid the consumption of water.

The duration of the heating may vary from about 1 second to about 1 hour and, in particular, from about 5 seconds to about 5 minutes, for example, from about 15 seconds to 200 seconds, and in particular, from about 15 seconds to about 30 seconds.

The use of a heat source which does not contact the polyester textile during the heating may also allow control over bleeding and over-penetration of the water-based disperse dye ink composition on the polyester textile.

Although the method may use a calender for the heating (with contact times between 10 seconds and 60 seconds), it preferably uses a dry heat source which does not contact the polyester textile during the heating.

Accordingly, the heating may comprise heating the printed polyester textile with a remote dry heat source, such as a near infra-red (NIR) lamp.

The method may produce a printed polyester textile having at least one of a colour fastness to water of at least 3 according to ISO 105-E01:2010 without rinsing; a colour fastness to wet rubbing of at least 3 or a colour fastness of at least 4 according to ISO 105-X12:2001 without rinsing; and a colour fastness to acidic perspiration or a colour fastness to alkaline perspiration of at least 3 according to ISO 105-E04:2008 without rinsing.

As mentioned above, the inkjet printing may use a water-based disperse dye ink composition having a high surface tension—and in particular a water-based disperse dye ink composition described in International Patent Application WO 2014/127050 A1.

The water-based disperse dye ink composition may, therefore, comprise one or more polyols having at least 5 carbon atoms. The composition may, for example, comprise a single polyol or two different polyols having at least 5 carbon atoms.

The first polyol and the second polyol may each be selected from simple carbohydrates and, in particular, the group of carbohydrates consisting of sorbitol, xylitol, mannitol, arabitol, ribitol and dulcitol.

In embodiments, the disperse dye may be present in an amount from about 0.1% to about 10% by weight of the composition.

The disperse dye may, in particular, be selected from the group consisting of Disperse Blue 14, Disperse Blue 19, Disperse Blue 72, Disperse Blue 334, Disperse Blue 359, Disperse Blue 360, Disperse Orange 25, Disperse Yellow 54, Disperse Yellow 64, Disperse Red 55, Disperse Red 60, Macrolex Red H, Disperse Brown 27, Solvent Blue 67, Solvent Blue 70, Solvent Red 49, Solvent Red 160, Solvent Yellow 162, Solvent Violet 10, Solvent Black 29 and combinations thereof.

The aqueous carrier for the water-based ink composition may comprise a total amount of polyol having at least 5 carbon atoms of about 6% to about 30% by weight of the composition.

The amount of first polyol in the aqueous carrier may vary between about 1% to about 25% by weight of the composition and the amount of second polyol may vary between about 1% to about 25% by weight of the composition.

The aqueous carrier may further comprise an anionic surfactant in an amount from about 0.1% to about 6% by weight of the composition.

Suitable anionic surfactants include alkyl sulfates, alkyl ether sulfates, alkyl aryl sulfonates (for example, a linear alkyl benzene sulfonate), α-olefin sulfonates, alkali metal or ammonium salts of alkyl sulfates, alkali metal or ammonium salts of alkyl ether sulfates, alkyl phosphates, silicone phosphates, alkyl glycerol sulfonates, alkyl sulfosuccinates, alkyl taurates, alkyl sarcosinates, acyl sarcosinates, sulfoacetates, alkyl phosphate esters, monoalkyl maleates, acyl isothionates, alkyl carboxylates, phosphate esters, sulfosuccinates, lignosulfonates and combinations thereof. Other suitable anionic surfactants include sodium lauryl sulfate, sodium lauryl ether sulfate, ammonium lauryl sulfosuccinate, ammonium lauryl sulfate, ammonium lauryl ether sulfate, sodium dodecylbenzene sulfate, triethanolamine dodecylbenzene sulfate, sodium cocoyl isothionate, sodium lauroyl isothionate and sodium N-lauryl sarcosinate.

Note, however, that the total amount of lignosulfonate in the composition may not exceed 3% by weight of the composition because it is thought that the coloured lignosulfonate may show up in tests for colour fastness to water.

The aqueous carrier may further comprise a humectant in an amount from about 15% to about 45% by weight of the composition.

Suitable humectants may be selected from materials having high hygroscopicity and water solubility. Suitable humectants include glycerol, ethylene glycol, diethylene glycol, triethylene glycol, 2-pyrrolidone, urea, 1,3-dimethylimidazolinone, monopropylene glycol, hexylene glycol, N-ethylacetamide, 3-amino-1,2-propanediol, ethylene carbonate and 1,5-pentanediol.

The aqueous carrier may further comprise a non-ionic surfactant in an amount up to about 4% by weight of the composition.

Suitable non-ionic surfactants may be selected from the group consisting of mono- and di-alkanolamides, amine oxides, alkyl polyglucosides, ethoxylated silicones, ethoxylated alcohols, ethoxylated carboxylic acids, ethoxylated fatty acids, ethoxylated amines, ethoxylated amides, ethoxylated alkylolamides, ethoxylated alkylphenols, ethoxylated glyceryl esters, ethoxylated sorbitan esters, ethoxylated phosphate esters, block copolymers (for example, polyethylene glycol-polypropylene glycol block copolymers), glycol stearate, glyceryl stearate and combinations thereof.

The aqueous carrier may comprise water in an amount from about 20% to about 70% by weight of the composition. It may further comprise one or more additional components such as surfactants, defoamers, biocides and pH adjusters.

The ink compositions should have a viscosity suitable for inkjet printing. They may, in particular, have viscosity from about 1 centipoise (1 mPa·s) to about 50 centipoises (50 mPa·s) at 35° C. Preferably, however, the viscosity is below 20 centipoises (20 mPa·s), for example, 15 centipoises (15 mPa·s) or 10 centipoises (10 mPa·s) or below, at that temperature.

As mentioned above, the ink compositions may, in particular, have a surface tension between 35 dynes/cm (35 mN/m) and 50 dynes/cm (50 mN/m), in particular, between 40 dynes/cm (40 mN/m) and 50 dynes/cm (50 mN/m), and for example, between 43 dynes/cm (43 mN/m) and 50 dynes/cm (50 mN/m).

In a third aspect, the present disclosure provides a blank polyester textile which textile has, at least in part, a surface treated with a hydrophobic coating.

References herein to a blank polyester textile are references to a polyester textile which is not printed upon—although it may have been treated in some way before its treatment with a hydrophobic coating.

Embodiments of the third aspect will be apparent from the embodiments of the first aspect of the present disclosure.

The blank polyester textile may have a hydrophobic coating providing that a degree of sharpness for a digitally printed image on the printing surface of the polyester textile which is better than that of a correspondingly printed image on the untreated polyester textile.

As mentioned above, the degree of sharpness of a digitally printed image on the printing surface of the polyester textile may correlate with the difference between the surface free energy of the polyester textile and the surface tension of a water-based, disperse dye ink.

The difference may be managed by selection of the polymer forming the hydrophobic coating and/or the process conditions (for example, power, time and flow rate of monomer in an atmospheric plasma process) by which it is deposited on the polyester textile.

The selection may, in particular, provide a hydrophobic coating for the blank polyester textile which is optimised for inkjet printing a water-based, disperse dye composition having a high surface tension.

In one embodiment, the blank polyester textile has a hydrophobic coating which imparts a measurable surface free energy which is selected for inkjet printing of a water-based disperse dye ink composition described in WO 2014/127050 A1.

In embodiments, the blank polyester textile has a hydrophobic coating which imparts a measurable surface free energy which is between 5 dynes/cm (5 mN/m) and 30 dynes/cm (30 mN/m), for example, between 10 dynes/cm (10 mN/m) and 15 dynes/cm (15 mN/m), lower than the surface tension of the water-based disperse dye ink composition. The measurable surface free energy of the polyester textile may, in particular, be between 15 dynes/cm (15 mN/m) and 35 dynes/cm (35 mN/m).

In certain embodiments, the blank polyester textile may comprise a woven polyester fabric of weight per unit area between 10 g/m² to 100 g/m².

In a fourth aspect, the present disclosure provides a method of printing of a polyester textile, the method comprising inkjet printing a water-based disperse dye ink composition, on a surface of the polyester textile which has, at least in part, been treated to increase its hydrophobicity; and heating the polyester textile so as to fix the printed image on the treated surface of the polyester textile.

Embodiments of the fourth aspect will be apparent from the embodiments of the first, second and third aspects of the present disclosure.

The method may enable inkjet printing the water-based disperse dye ink composition on the surface of the polyester textile with a degree of sharpness of the printed image which is better than that of a correspondingly printed image on the untreated polyester textile.

In some embodiments, the method comprises inkjet printing a water-based disperse dye ink composition having a surface tension of between 35 dyne/cm (35 mN/m) and 50 dyne/cm (50 mN/m), in particular, between 40 dyne/cm (43 mN/m) and 50 dyne/cm (50 mN/m), and, for example, between 43 dyne/cm (43 mN/m) and 50 dyne/cm (50 mN/m).

In some embodiments, the method comprises inkjet printing the water-based disperse dye ink composition on a surface of a polyester textile which has been provided with a hydrophobic coating imparting a measurable surface free energy which is 5 dynes/cm (5 mN/m) to 30 dynes/cm (30 mN/m), for example, 10 dynes/cm (10 mN/m) to 15 dynes/cm (15 mN/m), lower than the surface tension of the water-based disperse dye ink composition.

In certain embodiments, the inkjet printing may be on a surface of a polyester textile having weight per unit area between 10 g/m² to 100 g/m² which has been provided with a hydrophobic coating imparting a surface free energy which is between 15 dynes/cm (15 mN/m) and 35 dynes/cm (35 mN/m).

The inkjet printing may comprise inkjet printing directly onto the polyester textile or inkjet printing onto a transfer paper and transferring the printed image from the transfer paper to the treated polyester textile.

The method may comprise heating the polyester textile from about 100° C. to about a melting point of the polyester textile so as to fix a printed image on the treated surface of the polyester textile.

The printing may comprise inkjet printing directly onto the treated polyester textile and dry or wet heating the polyester textile to a temperature of at least 100° C., for example 120° C. or 130° C., within 60 seconds or less of having completed the inkjet printing.

The duration of the heating may vary from about 1 second to about 1 hour and, in particular, from about 5 seconds to about 5 minutes, for example, from about 15 seconds to 200 seconds, and in particular, from about 15 seconds to about 30 seconds.

Although the method may use a calender for the heating (with contact times between 10 seconds and 60 seconds), it preferably uses a dry heat source which does not contact the polyester textile during the heating.

Accordingly, the heating may comprise heating the printed polyester textile with a remote dry heat source, such as a near infra-red (NIR) lamp.

In a fifth aspect, the present disclosure provides a polyester textile which has, at least in part, a surface carrying a hydrophobic coating and a printed image formed by inkjet printing a water-based disperse dye ink composition of high surface tension.

Embodiments of the fifth aspect will be apparent from the embodiments of the first to fourth aspects of the present disclosure.

The polyester textile may, in particular, carry a printed image on a hydrophobic coating which has been formed by inkjet printing a water-based disperse dye ink composition having a surface tension of between 35 dyne/cm (35 mN/m) and 50 dyne/cm (50 mN/m), in particular, between 40 dyne/cm (43 mN/m) and 50 dyne/cm (50 mN/m), and, for example, between 43 dyne/cm (43 mN/m) and 50 dyne/cm (50 mN/m).

Note that the measurable surface free energy of the polyester textile may be substantially similar to the measurable surface free energy of the surface of the blank polyester textile which is treated with a hydrophobic coating.

In some embodiments, the measurable surface free energy of the polyester textile may, in particular, be between 15 dynes/cm (15 mN/m) and 35 dynes/cm (35 mN/m).

In certain embodiments, the polyester textile may comprise a woven polyester fabric of weight per unit area 10 g/m² to 100 g/m².

The present disclosure will now be described in more detail with reference to the following Examples and the accompanying drawings in which:

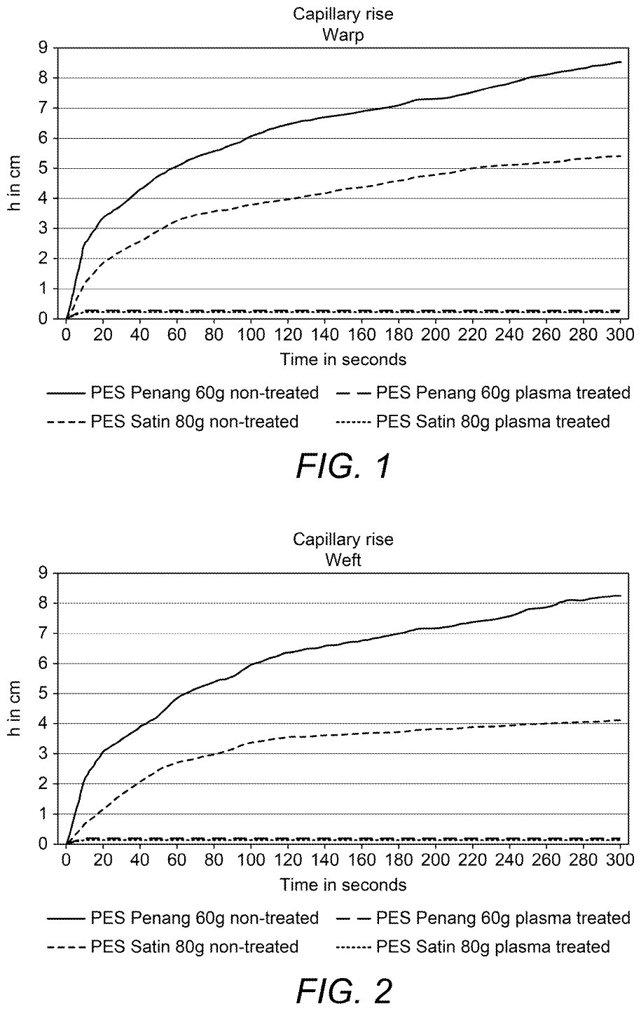

FIG. 1 is a graph showing plots of height of capillary rise in the warp direction against time of untreated and surface treated thin woven polyester fabrics during a standard capillary rise test (DIN 53924);

FIG. 2 is a graph showing plots of height of capillary rise in the welt direction against time of untreated and surface treated thin woven polyester fabrics during a standard capillary rise test (DIN 53924);

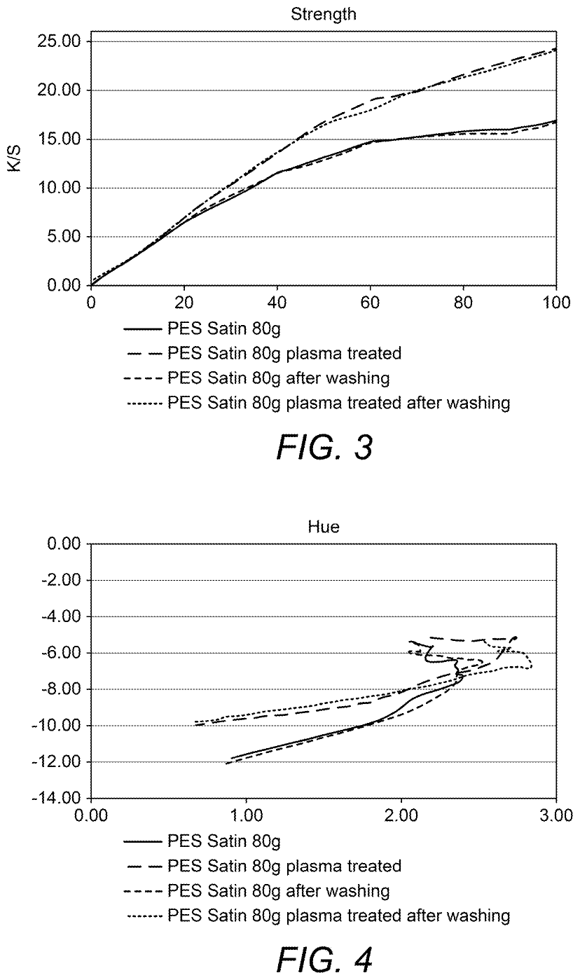

FIG. 3 is a graph obtained by optical reflectance studies showing plots of absorption/scattering (K/S) of light against percentage of an ink composition comprising a disperse dye and an aqueous carrier comprising a polyol having at least 5 carbon atoms inkjet printed on an untreated and a surface treated thin woven polyester fabric before and after washing;

FIG. 4 is a graph obtained by optical reflectance studies showing 2 dimensional plots of a CIELAB colour space (a* against b*) of the ink composition inkjet printed on an untreated and a surface treated thin woven polyester fabric before and after washing;

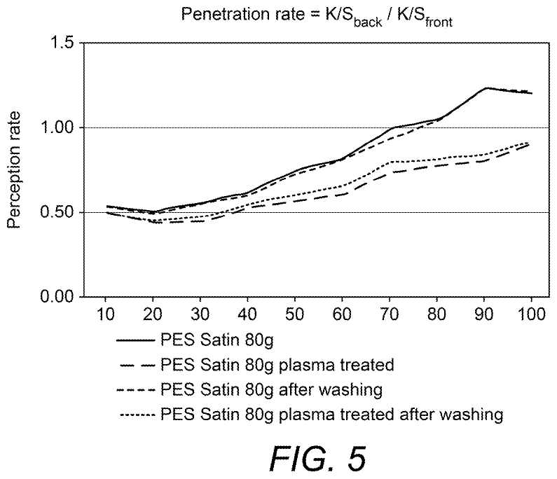

FIG. 5 is a graph obtained by optical reflectance studies showing plots of the ratio of front and back absorption/scattering (K/S)) against percentage of the ink composition inkjet printed on an untreated and a surface treated thin woven polyester fabric before and after washing;

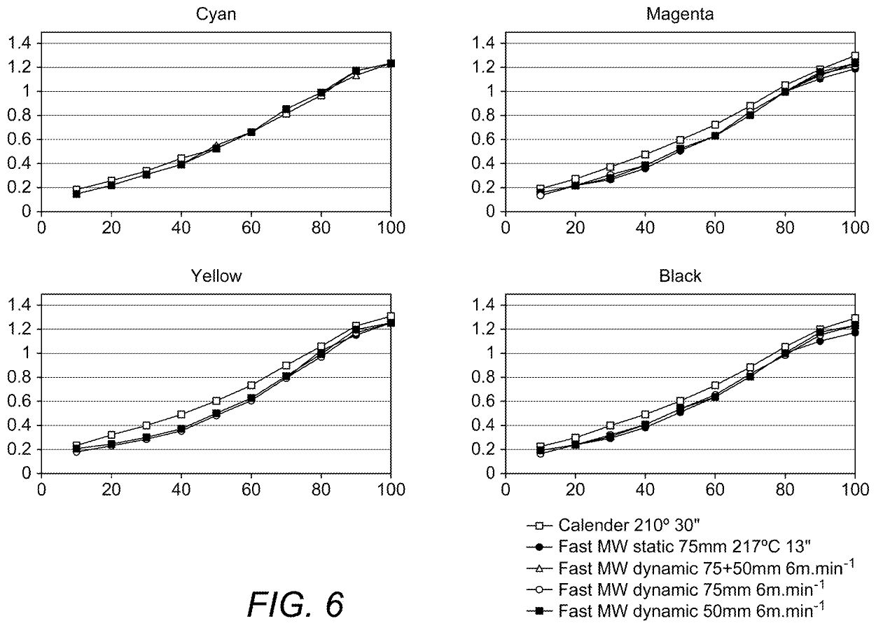

FIG. 6 shows graphs plotting percentage ink (abscissa) against optical density (ordinate; OD=log₁₀(1/R) where R is reflectance) of a linearization test pattern comprising 10 patches (10% to 100%) on a touch satin polyester fabric formed by inkjet printing ink compositions comprising a disperse dye and an aqueous carrier comprising a polyol having at least 5 carbon atoms following heating with near infra-red lamps as compared to heating with a calendar; and; and

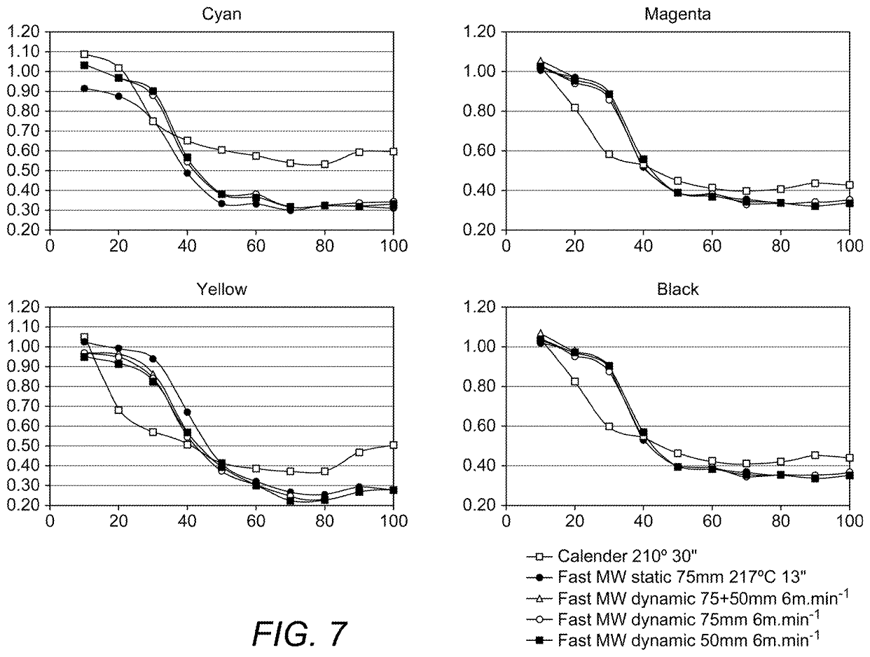

FIG. 7 shows graphs plotting percentage ink (abscissa) against the ratio (ordinate) of optical densities front and back (OD_{back}/OD_{front}) of a linearization test pattern comprising 10 patches (10% to 100%) on a touch satin polyester fabric formed by inkjet printing ink compositions comprising a disperse dye and an aqueous carrier comprising a polyol having at least 5 carbon atoms following heating with near infra-red lamps as compared to heating with a calendar.

### EXAMPLE 1

An atmospheric pressure plasma treatment was carried out on two commercially available thin woven polyester textiles herein designated PES Penang 60 g and PES Satin 80 g.

PES Satin 80 g is a woven fashion 100% polyester satin fabric of weight per unit area 80 g/m² which can be purchased from many suppliers in China.

PES Penang 60 g is a woven fashion 100% polyester fabric of weight per unit area 60 g/m² which can be purchased from suppliers in China and Indonesia. Technical data for these polyester (PES) textiles are shown in Table 1.

The treatment used a PLATER® atmospheric plasma technology apparatus (from GRINP® s.r.l., Italy) providing for roll-to-roll processing of the textiles through a plasma source providing a dielectric barrier discharge between electrodes of surface area 50 cm² .

Samples of each textile were exposed to a plasma generated at a temperature of 140° C. by a continuous dielectric barrier discharge (at 690 W) in air containing hexamethyldisiloxane (HMDS). The flow rate of the air mixture to the plasma source was held at 1.2 ml per minute. The feed of each textile between the electrodes was held at 8 metres per minute and repeated through sixteen roll-to-roll cycles.

TABLE 1

| | Weight | Yarn count (DEN) | | Yarns/cm | |
|---|---|---|---|---|---|
| PES Textile | (g/m2) | Weft | Warp | Weft | Warp |
| PES Penang 60 g | 60 | 80 | 80 | 32 | 44 |
| PES Satin 80 g | 80 | 50 | 30 | 46 | 110 |

The treatment was determined to lower the surface energy of the thin woven polyester textile by a drop test using mixtures of distilled water and isopropanol (IPA).

In this test, the contact angles of the mixtures on the treated polyester textiles were roughly determined using an optical microscope and compared with the contact angles of the mixtures on the untreated polyester textiles. Table 2 tabulates the results of the test.

TABLE 2

| | | PES Penang 60 g | | PES Satin 80 g | |
|---|---|---|---|---|---|
| % Composition | | Contact Angle/° | | Contact Angle/° | |
| Water | IPA | untreated | treated | untreated | treated |
| 100 | 0 | 0 | >90 | <45 | >90 |
| 98 | 2 | 0 | >90 | <45 | >90 |
| 95 | 5 | 0 | >90 | 0 | >90 |
| 90 | 10 | 0 | <45 | 0 | <45 |
| 80 | 20 | 0 | 0 | 0 | 0 |
| 70 | 30 | 0 | 0 | 0 | 0 |
| 60 | 40 | 0 | 0 | 0 | 0 |

As may be seen, the contact angle of all the mixtures on untreated PES Penang 60 g were zero. The contact angle of distilled water on untreated PES Satin 80 g was less than 45° with penetration occurring within 30 seconds. The contact angle of the water and isopropanol mixture 98:2 on untreated PES Satin 80 g was also less than 45° but penetration occurred within 5 seconds.

Mixtures of water and isopropanol in which the percentage isopropanol is below 10% showed contact angles greater than 90° on treated PES Satin 80 g and treated PES Penang 60 g—these results indicating that the treated polyester textiles showed little or no wettability as compared with the untreated polyester textiles.

Capillary rise tests on treated and untreated samples of PES Satin 80 g and PES Penang 60 g were carried out according to DIN 53924. The samples were conditioned at 35% relative humidity at a temperature of 25° C. for 12 hours prior to the test. Triplicate strips of the treated samples were suspended vertically in a mixture of deionised water and isopropanol (or 1,5-pentadiol) containing a blue dye (CI RB49) and having a surface tension of 40 dynes/cm (40 mN/m). The rise in capillary height in warp and weft directions of the samples was examined over a period of 5 minutes in time intervals of 30 seconds.

FIGS. 1 and 2 show plots of the results of these test—it being clear that the wicking height of the treated samples in each direction is near zero throughout the whole period whereas the wicking height of the untreated samples quickly rises.

### EXAMPLE 2

Treated and untreated samples of PES Satin 80g was subjected to inkjet printing using a Reggiani ReNOIR Compact 180 (600 dpi×600 dpi) inkjet printer and a black water-based disperse dye ink composition comprising a polyol having more than 5 carbon atoms.

The black water-based disperse dye ink composition and other suitable disperse dye ink compositions are described in Tables 3 and 4. The inkjet printing provided a (calendar) contact time of 1 minute before fixing by dry heating at a temperature of 210° C. for 30 seconds.

Some of the printed samples were subjected to washing immediately following the printing. The washing was carried out by immersion in water with stirring at a temperature of 40° C. for 30 minutes. The colour strength and colour hue on the printed surface and the extent of penetration of colour was examined after the washing and compared with printed samples which were not washed.

FIG. 3 is a graph obtained by optical reflectance studies (on a GretagMacbeth Spectrolino® spectrometer D19C, D196, D118, RD-19, SPM 50/55/60/100) with KeyWizard V2.5 software from X-Rite Europe GmbH, Switzerland) showing plots of absorption/scattering (K/S) on the printed surface of ten treated and untreated samples of PES Satin 80 g wherein the percentage dye in the ink composition varies before and after the washing.

As may be seen, the colour strength is significantly greater (up to 25%) on the printed surface of the treated sample as compared to the printed surface of the untreated sample—both before and after the washing.

TABLE 3

| | % by weight C | |
|---|---|---|
| Component (C) | Yellow | Red |
| Dye Disperse Yellow 54 | 2.70 | |
| Dye Disperse Red 60 | | 5.50 |
| Propoxylated Glycerol | 23.00 | 19.00 |
| Glycerol | 0.97 | |
| Xylitol | 4.00 | 4.00 |
| Sorbitol | 8.00 | 8.00 |
| Urea | 0.50 | 1.00 |
| Napthalenesulfonic acid, Na+ salt | 2.00 | |
| Block Copolymer Non-ionic Surfactant | 3.97 | |
| PE Block Copolymer Non-ionic Surfactant | | 1.82 |
| Alkylbenzene Sulfonate Anionic Surfactant | 0.20 | |
| Alkylnaphthalene Sulfonate Anionic Surfactant | 0.10 | 0.10 |
| Lignosulfate | | 1.00 |
| Acrylic Based Anionic Surfactant | | 1.50 |
| Defoamer | 0.05 | 0.02 |
| Biocide | 0.80 | 0.40 |
| Water | Balance | Balance |

FIG. 4 is a graph obtained by optical reflectance studies showing 2 dimensional plots of a CIELAB colour space (a* against b*; ink compositions of Tables 2 and 3) on the printed surface of treated and untreated samples of PES Satin 80 g before and after the washing.

TABLE 4

% by weight C

| Component (C) | Blue | Black |
|---|---|---|
| Dye Disperse Yellow 54 | | 0.50 |
| Dye Disperse Blue 359 | 5.00 | |
| Dye Disperse Blue 360 | | 3.80 |
| Dye Disperse Orange 25 | | 2.70 |
| Propoxylated Glycerol | 17.00 | 16.00 |
| Xylitol | 5.30 | 4.00 |
| Sorbitol | 8.00 | 7.00 |
| Urea | 1.00 | |
| Napthalenesulfonic acid, Na+ salt | | |
| Block Copolymer Non-ionic Surfactant | | 4.70 |
| PE Block Copolymer Non-ionic Surfactant | 2.60 | 0.30 |
| Alkylbenzene Sulfonate Anionic Surfactant | | 0.50 |
| Lignosulfate | 3.07 | |
| Acrylic Based Anionic Surfactant | 1.50 | 1.50 |
| Defoamer | 0.05 | 0.06 |
| Biocide | 0.20 | 0.30 |
| Water | Balance | Balance |

As may be seen, the colour hue is significantly better on the printed surface of the treated sample as compared to the printed surface of the untreated sample—both before and after washing.

FIG. 5 is a graph obtained by optical reflectance studies showing plots of the ratio of front and back absorption/scattering (K/S)) against percentage of the ink composition inkjet printed on an untreated and a surface treated thin woven polyester fabric before and after washing.

As may be seen, the ratio is significantly higher (up to 25% higher) for the treated sample as compared to the untreated sample—indicating that unwanted penetration of the ink composition is significantly less on the treated sample as compared to the untreated sample.

### EXAMPLE 3

The inkjet printing of three water-based, disperse dye ink compositions of different surface tensions (A to C) on a surface treated (touch satin) polyester textile (100%) having weight per unit area of 180 g/m² was studied.

Ink composition B corresponds to black of Table 4 and ink composition A and B differed only in an added amount of an ethoxylated non-ionic surfactant (0.20% for ink composition A and 0.50% for ink composition C) lowering surface tension.

The (static) surface tensions of the ink compositions A to C were determined (using the ring method of Du Noüy) as 38 to 39 dynes/cm (38 to 39 mN/m) for B; 31 to 32 dynes/cm (31 to 32 mN/m) for A and 27 to 28 dynes/cm (27 to 28 mN/m) for C (that is B>A>C).

In a first experiment, the polyester textile was treated by exposure to a plasma (Plasma 1) containing hexamethyldisiloxane (HMDS) in helium in atmospheric plasma technology apparatus (PLATER® 1000 LAB from GRINP® s.r.l., Italy) providing for roll-to-roll processing of the textile through a plasma source providing a dielectric barrier discharge between electrodes of surface area 50 cm² .

TABLE 5

| | Plasma 1 | Plasma 2 |
|---|---|---|
| Monomer | HMDS | HMDS |
| Gas | He | He |
| Flow rate Gas l/min | 10 | 10 |
| % chemistry | 80 | 80 |
| Distance [mm] | 1 | 1 |
| Evaporator [° C.] | 140 | 140 |
| Thermo [° C.] | 72 | 72 |
| Speed [m/min] | 2 | 4 |
| Power [W] | 3500 | 2500 |

In a second experiment, the polyester textile was treated by exposure to a plasma (Plasma 2) containing hexamethyldisiloxane (HMDS) in the same apparatus but under different conditions as compared to the first experiment. The particular conditions for the first and second experiments are set out in Table 5.

The printing to each of the treated polyester textiles was carried out by inkjet printing the water-based, disperse dye ink compositions at using a Reggiani ReNOIR Compact 180 inkjet printer (600×600 dpi; IL 300%) and immediately heating on a calendar (Monti Antonio S.p.A, Italy; Model 72-2600) at 210° C. and 1.9 bar for 30 seconds.

The resultant samples (one for each water-based disperse dye ink composition) were examined for rub fastness according to BS EN ISO 105-X12:2016 and the optical density (OD) and penetration (P) of the ink composition for each sample in the best case (the first experiment) determined.

Table 6 tabulates the relative percentage changes in optical density and penetration in each sample as compared to the untreated polyester textile.

As may be seen, the ink composition having the highest surface tension (B) shows the highest optical density and the lowest penetration in the printed image as compared to inkjet printing on the untreated polyester textile.

Note that although optical density is not an absolute measure of the sharpness of a printed image, it does generally indicate sharpness because (as can be inferred from FIGS. 1 and 2) an ink composition showing less penetration of the polyester textile will also show less dot gain.

TABLE 6

| | Experiment 1 | | Experiment 2 | |
|---|---|---|---|---|
| | OD/% | P/% | OD/% | P/% |
| Ink Composition A | +20% | −15% | +6% | −8% |
| Ink Composition B | 3% higher | 10% lower | — | — |
| | than A | than A | | |
| Ink Composition C | 3% lower | 5% lower | — | — |
| | than A | than B | | |

### EXAMPLE 4

The influence of heating with one or two near infra-red lamps (of diameter 50 mm or 75 mm) on the penetration of different water-based disperse dye compositions (cyan, magenta, yellow and black) of similar surface tension on the treated polyester textile (first experiment) of Example 3 was examined.

The near infra-red lamps were of the fast medium wave emitter type having a radiation peak of 1.4 μm to 1.6 μm, 50 W/cm maximum density of nominal power and 130 kW/m² maximum surface power density.

The inkjet printing (according to Example 3) printed an image (across 100% of the selected area) in which the ink composition density was 7 to 8 g/m².

The heating was carried out under various conditions in which the polyester was held still (in a 1 m oven) beside the near infra-red lamp or lamps or passed by at a pass rate of the polyester textile of 6 metres per minute.

The optical densities of the samples so obtained were compared with that obtained from heating on a calendar as described in Example 3.

FIGS. 6 and 7 show respectively graphs plotting percentage ink against optical density (OD=log₁₀(1/R) where R is reflectance) and percentage ink against the ratio of optical densities front and back (OD_{back}/OD_{front}) of a linearization test pattern comprising 10 patches (10% to 100%) for each ink composition and each of the heating conditions on a touch satin polyester fabric.

As may be seen, although the optical densities of the printed images do not appear to differ significantly, the penetration of the ink compositions on the treated polyester textile is reduced by an amount between 20% and 50% by heating with near infra-red lamp or lamps as compared to heating with a calendar.

### EXAMPLE 5

The colour fastnesses of the samples of Example 4 obtained by heating the polyester textile under two near infra-red lamps (of diameter 75 mm and 50 mm) at a pass rate of polyester textile of 6 metres per minute were compared with the colour fastness of the sample obtained by calendar heating in a rubbing test in accordance with BS EN IS) 105-X12: 2016 Rubbing.

The dry and wet colour fastnesses (face and length) of the near infra-red heated samples was largely comparable with the dry and wet colour fastness of the calendar heated sample (4 to 5).

Further, the colour fastnesses of near infra-red heated samples obtained from binary and quaternary mixtures of the water-based, disperse dye ink compositions of Example 4 on the polyester textile of Example 3 were also largely comparable to the dry and wet colour fastness of the corresponding calendar heated sample (4 to 5).

The present disclosure provides an improved method for digital printing of water-based disperse dyes onto polyester textiles.

The method is particularly useful for digital printing of water-based disperse dyes having relatively high surface tension to low commercial grade polyester textiles—allowing precise XYZ axis positioning control of the water-based disperse dye ink compositions on these polyester textiles.

The present disclosure may provide a printed polyester textile having colour fastness to water, colour fastness to wet and dry rubbing and colour fastness to light on polyester textiles which are similar to the printed polyester textiles described in WO 2014/127050 A1.

The present disclosure offers substantially water-free printing to polyester textiles. This water-free printing is particularly suitable for the decoration of low grade commercial polyester textiles which are to be used as fashion wear and sportswear.

The presently disclosed methods and polyester textiles have been described in detail having regard to a limited number of embodiments and Examples. It will be appreciated, however, that other embodiments and examples, which are not described in detail herein, are possible provided that they fall within the scope of the accompanying claims.

Note that references to values of surface tension herein are references to static surface tension values which are known in the literature or can be measured in accordance with a known standard method (or DIN) such as the ring method of Du Noüy.

Note further that ranges defined herein include the beginning and end values—references to “about” being references to values including the exact value as well as values which achieve the same result. Such values may, for example, be within one decimal place of the exact value.

1. A method of pre-treating a polyester textile for inkjet printing with a water-based disperse dye ink composition, which method comprises treating at, least a part of, a surface of the polyester textile to increase its hydrophobicity.

2. A method according to claim 1, comprising forming a hydrophobic polymer coating on the surface providing for optimal inkjet printing of a water-based, disperse dye ink composition having a surface tension between 35 dynes/cm (35 mN/m) and 50 dynes/cm (50 mN/m).

3. A method according to claim 2, wherein the hydrophobic coating imparts a measurable surface free energy from 5 dynes/cm (5 mN/m) to 30 dynes/cm (30 mN/m) lower than the surface tension of the water-based disperse dye ink composition.

4. A method according to claim 3, wherein the measurable surface free energy is between 15 dynes/cm (15 mN/m) and 35 dynes/cm (35 mN/N).

5. A method according to claim 1, wherein the pre-treating comprises an atmospheric plasma process using one or more of a silicon-containing compound in air.

6. A method according to claim 1, wherein the polyester textile is a woven polyester fabric of weight per unit area 10 g/m² to 100 g/m².

7. A method of digital printing of a polyester textile, which method comprises pre-treating, at least a part of, a surface of a polyester textile so as to increase hydrophobicity; inkjet printing a water-based disperse dye ink composition on the treated surface of the polyester textile;
and heating the printed polyester textile so as to fix the printed image on the treated surface of the polyester textile.

8. A method according to claim 7, wherein

1. treating comprises a pre-treatment according to claim 1.

9. A method according to claim 8, wherein the inkjet printing comprises inkjet printing a water-disperse dye composition having a surface tension between 35 dynes/cm (40 mN/m) and 50 dynes/cm (50 mN/m) on the pre-treated surface of the polyester textile.

10. A method according to claim 7, wherein the heating comprises heating the printed polyester textile to a temperature of 100° C. to 130° C. within 60 seconds or less of the completion of the inkjet printing.

11. A method according to claim 7, wherein the heating comprises dry heating without directly contacting a heat source with the printed polyester textile.

12. A method according to claim 7, wherein the polyester textile is a woven polyester fabric of weight per unit area 10 g/m² to 100 g/m².

13. A method of printing to a polyester textile, the method comprising inkjet printing a water-based disperse dye ink composition on a surface of the textile which has, at least in part, been treated to increase its hydrophobicity; and heating the printed polyester textile so as to fix the printed image on the treated surface of the polyester textile.

14. A method according to claim 13, wherein the treated surface has a measurable surface free energy between 5 dynes/cm (5 mN/m) and 30 dynes/cm (30 mN/N) lower than the surface tension of the water-based, disperse dye composition.

15. A method according to claim 14, wherein the wherein the inkjet printing comprises inkjet printing a water-based, disperse dye composition having a surface tension between 35 dynes/cm (35 mN/m) and 50 dynes/cm (50 mN/m) on the pre-treated surface of the polyester textile.

16. A method according to claim 13, wherein the heating comprises heating the printed polyester textile to a temperature between 100° C. and 130° C. within 60 seconds or less of the completion of the inkjet printing.

17. A method according to claim 13, wherein the polyester textile is a woven polyester fabric of weight per unit area 10 g/m² to 100 g/m².

18. A blank polyester textile, which is at least in part, surface treated with a hydrophobic coating.

19. A blank polyester textile according to claim 18, wherein the surface has a measurable surface free energy between 15 dynes/cm (15 mN/m) and 35 dynes/cm (35 mN/N).

20. A blank polyester textile according to claim 19, comprising a woven polyester fabric having weight per unit area 10 g/m² to 100 g/m².

21. A printed polyester textile, comprising, at least in part, a surface treated with a hydrophobic coating wherein the treated surface carries a printed image formed by inkjet printing a water-based disperse dye ink composition on the treated surface of the polyester textile.

22. A printed polyester textile according to claim 21, which has a measurable surface free energy between 15 dynes/cm (15 mN/m) and 35 dynes/cm (35 mN/N).

23. A printed polyester textile according to claim 22, comprising a woven polyester fabric having weight per unit area 10 g/m² to 100 g/m².
